(19) United States
(12) Patent Application Publication
(10) Pub. No.: US 2013/0126212 A1
(43) Pub. Date: May 23, 2013

(54) CONDUCTIVE MEMBERS USING CARBON-BASED SUBSTRATE COATINGS

(71) Applicants: Rodney Ivan Martens, Mechanicsburg, PA (US); Andrew Nicholas Loyd, Dillsburg, PA (US); Jessica Henderson Brown Hemond, Mifflintown, PA (US); Zhengwei Liu, Houston, TX (US)

(72) Inventors: Rodney Ivan Martens, Mechanicsburg, PA (US); Andrew Nicholas Loyd, Dillsburg, PA (US); Jessica Henderson Brown Hemond, Mifflintown, PA (US); Zhengwei Liu, Houston, TX (US)

(73) Assignee: Tyco Electronica Corporation, Berwyn, PA (US)

(21) Appl. No.: 13/555,911

(22) Filed: Jul. 23, 2012

Related U.S. Application Data
(60) Provisional application No. 61/562,833, filed on Nov. 22, 2011.

(51) Int. Cl. H01B 5/00; B32B 37/14

(52) U.S. Cl. 174/126.2; 156/62.2

(57) ABSTRACT

A conductive member includes a metal substrate and a carbon-based substrate (CBS) network applied to the metal substrate. The CBS network includes a framework of fibers and particulates embedded in the framework that provide cathodic protection for the metal substrate. The particulates may penetrate entirely through the framework. The particulates may be iron particulates. The particulates may be metal particulates having a higher corrosion potential than the metal substrate. The CBS network may be a yarn, a sheet, or a tape. The CBS network with the particulates may be applied by coating or plating the metal substrate with the CBS network.

### CROSS REFERENCE TO RELATED APPLICATIONS

This application claims the benefit of U.S. Provisional Application No. 61/562,833 filed Nov. 22, 2011, titled CONDUCTIVE MEMBERS USING CARBON-BASED SUBSTRATE COATINGS, the subject matter of which is herein incorporated by reference in its entirety.

### BACKGROUND OF THE INVENTION

The subject matter herein relates generally to conductive members, such as conductors, that use carbon-based substrate (CBS) coatings.

CBSs may include carbon nanotubes (CNTs), graphene or other carbon-based networks as the base carrier for the nanoparticle coating. CBSs have use in a wide range of applications. Due to the advantageous properties exhibited by CBSs, CBSs have application in electrical systems, such as use with electrical conductors of cables, wires or other conductors, with electromagnetic interference (EMI) shielding for cables or other types of electronic components, and other applications. Due to the relative light weight of CBSs, as compared to traditional contact metal platings or coatings, CBSs have application in aeronautical application where weight is a significant design factor.

In some applications, the electrical systems are utilized in harsh environments, where corrosion is problematic. Typically, the metal conductors are plated with protective coatings or platings, such as gold and/or nickel layers. Such layers or platings may be expensive to use and apply.

A need remains for a CBS network that exhibits good corrosion protection characteristics.

### BRIEF DESCRIPTION OF THE INVENTION

In one embodiment, a conductive member is provided including a metal substrate and a carbon-based substrate (CBS) network applied to the metal substrate. The CBS network includes a framework of fibers and particulates embedded in the framework that provide cathodic protection for the metal substrate. Optionally, the particulates may penetrate entirely through the framework. The particulates may be iron particulates. The particulates may be metal particulates having a higher corrosion potential than the metal substrate. The CBS network may be a yarn, a sheet, or a tape. The CBS network with the particulates may be applied by coating or plating the metal substrate with the CBS network.

In another embodiment, a cable is provided including a jacket surrounding a core and a conductive member in the core. The conductive member includes a metal substrate and a carbon-based substrate (CBS) network applied to the metal substrate. The CBS network has particulates embedded therein that provide cathodic protection for the metal substrate.

Optionally, the particulates may be iron particulates. The particulates may be metal particulates having a higher corrosion potential than the metal substrate. Optionally, the CBS network may include a plurality of fibers forming a framework. The CBS network may be a yarn, a sheet, or a tape. Optionally, the CBS network with the particulates may be applied by coating the metal substrate with the CBS network or may be applied by plating the metal substrate with the CBS network. The CBS network may have a controlled level and distribution of the particulates throughout the entire CBS network.

Optionally, the conductive member may be a signal carrying conductor of the cable. The cable may include a plurality of the conductive members twisted along a length of the cable to form a central conductor of the cable. The conductive member may surround the core and provide EMI shielding for the core. The cable may be a coaxial cable having an insulator and a second conductive member in the core, where the insulator surrounds the conductive member, the second conductive member surrounds the insulator and the jacket surrounds the second conductive member. The second conductive member may provide EMI shielding for the other conductive member, which is configured to convey electrical signals between a first end and a second end of the cable.

In another embodiment, a method for manufacturing a conductive member includes providing a metal substrate, providing carbon-based substrate (CBS) based fibers to define a framework and embedding particulates in the framework. The particulates have a higher corrosion potential than the metal substrate. The method includes applying the framework with the embedded particulates to the metal substrate to provide cathodic protection for the metal substrate.

Optionally, the embedding may include immersing at least a portion of the framework in a metallic bath. The providing CBS based fibers may include extracting CBS fibers from a CBS array to form the framework having a shape of a yarn, a tape or a sheet. The method may include post-processing the framework and the particulates.

### BRIEF DESCRIPTION OF THE DRAWINGS

FIG. 1 is a cross-sectional view of a cable formed in accordance with an exemplary embodiment.

FIG. 2 is a cross sectional view of a conductive member formed in accordance with an exemplary embodiment that may be used in an electrical system.

FIG. 3 is an enlarged view of a portion of a carbon-based substrate (CBS) network for the conductive member.

FIG. 4 illustrates a cable extending between a first and a second end using the conductive member.

FIG. 5 illustrates a solar cell using the conductive member.

FIG. 6 illustrates an environmental sensor using the conductive member.

FIG. 7 illustrates a processor system for manufacturing a conductive member in accordance with an exemplary embodiment.

FIG. 8 is a flow chart showing a method of manufacturing a cable in accordance with an exemplary embodiment.

### DETAILED DESCRIPTION OF THE INVENTION

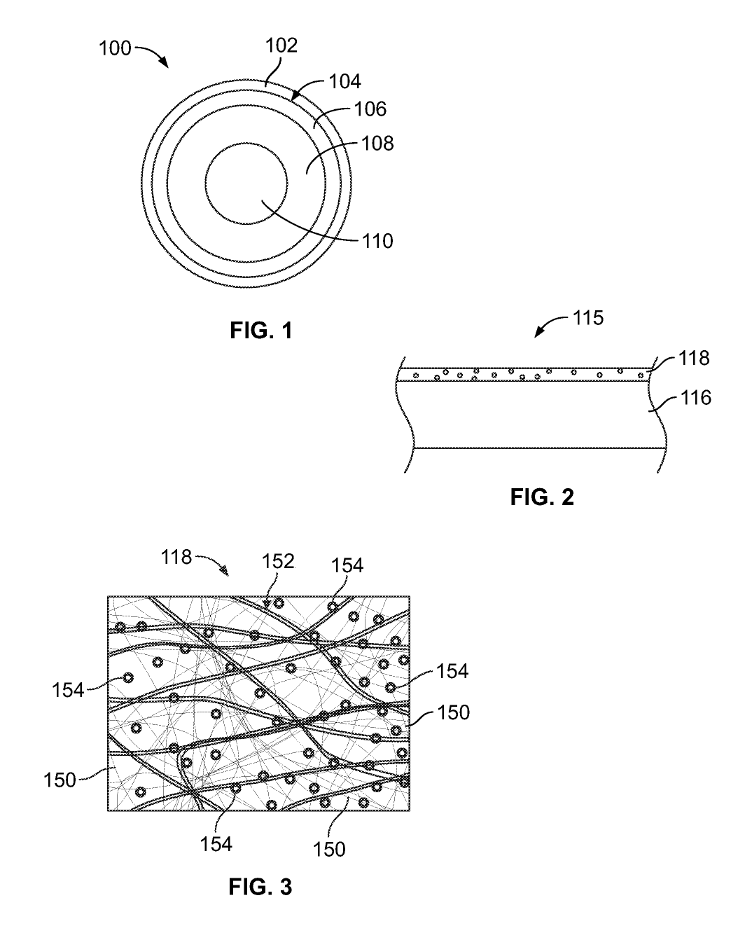

FIG. 1 is a cross-sectional view of a cable 100 formed in accordance with an exemplary embodiment. The cable 100 includes a jacket 102 defining a core 104. An EMI shield 106 is in the core 104 and is surrounded by the jacket 102. An insulator 108 is in the core 104 and is surrounded by the EMI shield 106. A center conductor 110 is in the core 104 and is surrounded by the insulator 108. The insulator 108 electrically isolates the center conductor 110 from the EMI shield 106. The insulator 108 is manufactured from a dielectric material. Optionally, the insulator 108 may be a shrink tube that is heat shrinkable. The jacket 102 is manufactured from a dielectric material. Optionally, the jacket 102 may be a shrink tube that is heat shrinkable. In an alternative embodiment, the cable 100 may not include a jacket, but rather the EMI shield 106 defines the outer surface of the cable 100. Optionally, the cable 100 may include a drain or ground wire.

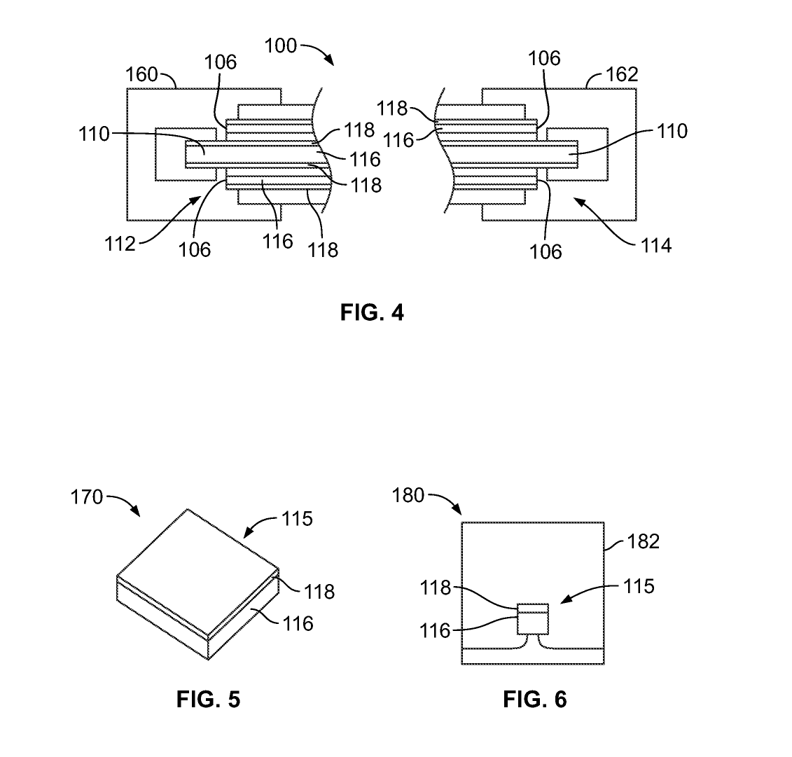

The EMI shield 106 and the center conductor 110 are electrically conductive. The cable 100 defines a coaxial cable having the center conductor 110 and an outer conductor defined by the EMI shield 106 extending along a common axis along the length of the cable 100. The cable 100 may be another type of cable, such as a twin-axial cable, a quad-axial cable, an unshielded cable, an unjacketed cable, and the like. The center conductor 110 is configured to convey electrical signals between a first end 112 (shown in FIG. 4) and a second end 114 (shown in FIG. 4) of the cable 100. In an exemplary embodiment, the center conductor 110 is configured to convey data signals. Alternatively, the center conductor 110 may convey power between the first and second ends 112, 114. In other alternative embodiments, the cable 100 may include more than one center conductors that define different electrical paths to convey different electrical signals.

FIG. 2 is a cross sectional view of a conductive member 115 that may be used in an electrical system. The conductive member 115 may be used as the EMI shield 106 (shown in FIG. 1), the center conductor 110 (shown in FIG. 1) or as a conductive member of another component of an electrical system. The conductive member 115 includes a metal substrate 116 that defines the main conductive feature thereof and a carbon-based substrate (CBS) network 118 over the metal substrate 116. The metal substrate 116 may be a wire, sheet, contact, terminal, panel or other structure. The metal substrate 116 may be manufactured from any metal material, such as copper, a copper alloy, or another metal. In an alternative embodiment, the conductive member 115 may not include the metal substrate 116, but rather, the CBS network 118 may define the main conductive feature of the conductive member 115.

The CBS network 118 may be a nanoparticle layer, such as a network using carbon nanotubes (CNTs), graphene, a graphite oxide structure, and the like. Alternatively, the network may be manufactured from another nano-substrate, such as a ceramic nanowire, such as a boron nitride substrate. The network 118 may be applied to the metal substrate 116 by plating, spray coating, dip coating or another application process.

In an exemplary embodiment, the network 118 is modified to give the network 118 corrosion resistance properties or other advantageous properties. For example, a CNT mesh or fabric may be created with particulates embedded therein. The particulates may be embedded by any appropriate process, such as by being a catalyst embedded during manufacture of the CNT mesh, by bathing the CNT mesh or fabric in a solution having the particulates therein, or by other processes. The network 118 may have a controlled and level distribution of particles embedded therein that result in a physical barrier for the metal substrate 116 when applied thereto. The particulates may provide cathodic protection of the metal substrate 116. In an exemplary embodiment, the network 118 includes iron particulates embedded in the network 118. Other types of particulates may be used in alternative embodiments, such as nickel or aluminum particles. The particulates may be less noble and/or have a higher corrosion potential than the metal of the metal substrate 116 such that the particulates react before or more easily than the metal of the metal substrate 116. In this manner, the network 118 defines a sacrificial layer where the particulates create a reaction that would corrode preferentially or prior to the metal corroding.

The network 118 functions as a physical barrier to the environment. The network 118 improves properties of the conductive member 115, such as improving wear. The integrity of the metal substrate 116 could be maintained in harsh environments, such as in applications such as off-shore drilling, energy harvesting, marine applications, aeronautical applications, and the like. The network 118 may define a layer on the metal substrate 116 that is thinner than other coatings or layers typically applied to the metal substrate 116 for corrosion resistance. The network 118 may be a thinner layer than other coatings or layers typically applied to the metal substrate 116 for corrosion resistance. For example, when used as part of a fine magnet wire, the network 118 may replace varnish layers typically applied to the fine wires, decreasing the overall thickness of the wire. In such applications, the pitting or pin holes typical of the varnish are overcome by using the corrosion resistant network 118 and multiple layers of varnish are not needed, which tends to make the final product more expensive. The network 118 may be manufactured more cost effectively than other systems that use precious metals, such as nickel and gold, for coating or plating. The CNT mesh of the network 118 may provide a physical barrier to protect the underlying substrate 116, in addition to the cathodic protection. For example, when used as part of a solar cell having a nickel substrate, the application of the network 118 having iron particulates embedded in the CNT mesh would provide both cathodic protection as well as a physical barrier over the nickel cell.

The network 118 may have other particulates embedded therein that give the network 118 other advantageous characteristics, such as electrically conductive properties or dielectric or insulating properties. The network 118 may be modified to make other compounded/composite surfaces.

In an exemplary embodiment, the conductive member 115 may be used as, or used as part of, an environmental sensor or filter used to monitor for harmful gases. For example, when used in a chemical sensor used to measure for impurities in the air, such as in an industrial application, the electrical characteristics of the metal substrate 116 may be continuously monitored. The network 118 may include a particulate that reacts with a particular chemical or gas that the chemical sensor is monitoring for. In the presence of the gas or chemical, the particulate will react, which has an effect on the electrical properties of the conductive member. Such change in the electrical characteristics are determined to be as a result of reaction with the harmful chemical or gas and the sensor will alaim or alert the system as to such presence of the chemical or gas.

FIG. 3 illustrates an exemplary CBS network 118. In the illustrated embodiment, the CBS network 118 includes a plurality of CBS fibers 150, such as CNT fibers, that are arranged to form a framework 152 that defines the CBS network 118. The framework 152 may be in the form of a mesh or a bundle. The CBS network 118 is metalized with particulates 154 to enhance the characteristics of the CBS network 118. The particulates 154 may be iron, nickel, aluminum or other metal particles. Optionally, the CBS network 118 may be placed into a metallic bath for embedding or infusing the particulates 154 in the CBS network 118. All or portions of the CBS network 118 may include the particulates 154. A controlled level and distribution of the particulates 154 may be embedded in the framework 154. The particulates 154 may be applied within the framework 152 by an electroplating process. The CBS network 118 may formed using other processes in alternative embodiments, such as physical vapor deposition, metallo-organic CVD in-situ, dip coating in conductive ink/paste, or other processes to provide the particulates 154. The particulates 154 may penetrate entirely through the framework 152 (e.g. be located at the top, middle and bottom) and the amount of penetration may be controlled by controlling the amount of time, the concentration of the metal and/or current that the CBS network is subjected to in the process. The characteristic enhancement (e.g. corrosion resistance) may be tuned by controlling the concentration and/or time of exposure in the metallic bath.

In an exemplary embodiment, the framework 152 may be pulled from a CBS array or CBS source, such as by using a spinning technique. The framework 152 may be formed into a yarn or wire. The framework 152 may be a braided yarn or a mesh. Alternatively, the framework 152 may be formed into a tape. Alternatively, the framework 152 may be formed into a sheet. The wire, tape or sheet may have any length depending on the particular application. A wire is defined as having a width that is less than approximately two times a thickness of the framework 152. A tape is defined as having a width that is greater than approximately two times the thickness of the framework 152 and having a width that is less than approximately ten times the thickness of the framework 152. A sheet is defined as a framework having a width that is greater than approximately ten times the thickness of the framework 152. The framework 152 may have different shapes depending on the particular application.

The wires or yarns may be used, for example, to define the strands of the center conductor 110 (shown in FIG. 1). The tapes may be used, for example, to form the EMI shield 106 (shown in FIG. 1), wherein the framework 152 may be wrapped around the internal components of the cable 100 such that the opposite edges of the framework 152 touch one another or overlap one another. In other embodiments, the tape may be wrapped in a helical manner around the insulator and center conductor 108, 110 to form an EMI shield. In other alternative embodiments, the tapes may be used to form wires or conductors of a cable, such as by drawing the tape during a cable forming process. The drawing of the tape may occur either pre or post metalizing. The sheet may be used, for example, as an EMI shield that covers an electrical component, such as a solar panel or a housing of a connector to provide EMI shielding for the connector. The framework 152 may have any other shape suitable for the particular application capable of being formed from a CBS structure.

FIG. 4 illustrates the cable 100 extending between the first and second ends 112, 114. The cable 100 may have any length defined between the first and second ends 112, 114. The first end 112 is terminated to a first electrical component 160. The second end 114 is terminated to a second electrical component 162.

The first and second electrical components 160, 162 are represented schematically in FIG. 4. The first and second electrical components 160, 162 may be any type of electrical component. Optionally, the first electrical component 160 may be different than the second electrical component 162. The electrical components 160, 162 may be electrical contacts, electrical connectors, circuit boards, sensors, solar cells, or other types of electrical components. The center conductor 110 and/or EMI shield 106 may be electrically connected to the electrical components 160, 162. The center conductor 110 and/or EMI shield 106 are configured to electrically connect the first and second electrical components 160, 162.

The metal substrate 116 of the CBS conductor is conductive and conveys electrical signals between the first and second electrical components 160, 162. The CBS network 118 may enhance the properties of the center conductor 110 and/or EMI shield 106. For example, the network 118 provides a physical barrier for the metal substrate 116 and provides cathodic protection of the substrate 116.

FIG. 5 illustrates a solar cell 170 defining the conductive member 115. The solar cell 170 uses a nickel metal substrate 116 with the CBS network 118 having a CNT mesh with iron particulates. The iron network 118 offers cathodic protection for the solar cell 170. The network 118 may be applied by spray-coating.

FIG. 6 illustrates an environmental sensor 180 defining the conductive member 115. A housing 182 holds the environmental sensor 180. The environmental sensor 180 may be used in a harsh environment that may be subject to one or more harmful chemicals or gases. The environmental sensor 180 monitors for the chemical or gas and may provide an alarm or alert if the chemical or gas is detected. The metal substrate 116 forms a contact or conductor of a sense circuit. A system monitors the sense circuit and measures at least one electrical characteristic of the metal substrate 116, such as a current or voltage. When the chemical or gas is present, the particulate in the network 118 is affected, for example corroded, and the electrical characteristics of the environmental sensor are affected. The system treats such change in behavior of the sensor 180 as an indication that the chemical or gas is present.

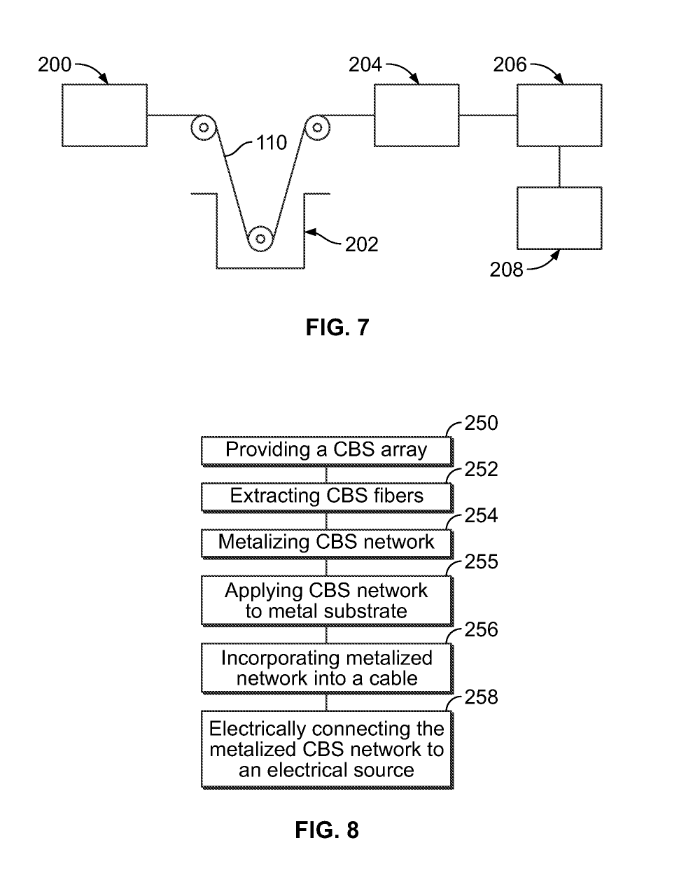

FIG. 7 illustrates a processor system for manufacturing a CBS conductor, such as the CBS conductor 110, in accordance with an exemplary embodiment. A CBS array 200 is provided as a source of carbon fibers, such as carbon nanotubes or carbon sheets. A metallic bath 202 is provided. An application module 204 is provided. A cable forming module 206 is provided. A storage module 208 is provided. Other modules may be provided in alternative embodiments.

During manufacture, CBS fibers are pulled or otherwise extracted from the CBS array 200 to make a framework or CBS network. The CBS network may be taken in the form of a wire or yarn, a tape, a sheet and the like. The CBS network is then metalized. In the illustrated embodiment, the CBS network is plated, however other processes may be used in alternative embodiments to metalize the CBS network. The CBS network is directed to the metallic bath 202 where the CBS network is plated with metal particulates. Optionally, the CBS network may be electroplated. The CBS network may be subjected to post processing, such as heating, cooling, shrinking, twisting, doping, densification, pressing, forming or other processes to affect the interaction between the particulates and the framework and/or to define a shape of the CBS network.

The metalized CBS network is directed to the application module 204. At the application module 204 the CBS network is applied to the metal substrate. For example, the CBS network may be spray-coated onto the metal substrate. The CBS network is placed in intimate contact with the metal substrate.

The CBS conductor is directed to the cable forming module 206 to form a cable, such as the cable 100 (shown in FIG. 1). At the cable forming module 206, one or more of the conductive members (such as the conductive members 115 shown in FIG. 2) are used to form the cable 100. For example, one or more conductive members in tape or sheet form may be wrapped around the center conductor to form an outer conductor or EMI shield. After the cable is formed, the cable may be stored at the storage module 208.

In alternative embodiments, rather than using the conductive members to form cables, the conductive members may be used to form other electrical components, such as an electrical connector, a solar cell, an environmental sensor, a processor, a circuit board, or another electrical component. The conductive members may be used as part of a signal conductor or alternatively may be part of an EMI shield or another part of an electrical component.

FIG. 8 is a flow chart showing a method of manufacturing a cable in accordance with an exemplary embodiment. The method includes providing 250 a CBS array as a source of fibers. The method includes extracting 252 CBS fibers from the CBS array to form a framework. The framework may be formed in any shape, such as a wire or yarn, a tape, a sheet or another shape. The method includes metalizing 254 the CBS network or framework, such as in a metallic bath or by another process. The metalizing may include embedding sacrificial particulates in the framework that provide corrosion protection. Optionally, the metalizing 254 may include electroplating. The method includes applying 255 the metalized CBS network to a metal substrate. The applying 255 may include coating, plating or similar processes. The metallized CBS network provides environmental protection for the metal substrate, such as cathodic protection.

The method includes incorporating 256 the metalized CBS network into a cable. For example, the CBS network may be presented to a cable forming machine that pulls the CBS network into a cable form within a jacket. The method includes electrically connecting 258 the CBS network to an electrical source to form a CBS conductor. For example, the CBS network may be soldered to a contact, a circuit board or another electrical component at one or both ends of the CBS network, and data signals may be conveyed along the CBS network between the opposite ends of the cable.

The metalized CBS network may be used in other types of electrical systems other than a cable, such as an electrical connector, a solar panel, an environmental sensor, a microprocessor, or another type of electrical component. Any application suitable for use with CBSs may utilize the metalized CBSs. The metalized layer on the CBS network enhances the characteristics of the CBS network, such as for corrosion resistance.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A conductive member comprising:
a metal substrate; and
a carbon-based substrate (CBS) network applied to the metal substrate, the CBS network comprising a framework of fibers and particulates embedded in the framework that provide cathodic protection for the metal substrate.

2. The conductive member of claim 1, wherein the particulates penetrate entirely through the framework.

3. The conductive member of claim 1, wherein the particulates comprise iron particulates.

4. The conductive member of claim 1, wherein the particulates are metal particulates having a higher corrosion potential than the metal substrate.

5. The conductive member of claim 1, wherein the CBS network includes a plurality of fibers forming a framework.

6. The conductive member of claim 1, wherein the CBS network with the particulates is applied by coating the metal substrate with the CBS network.

7. The conductive member of claim 1, wherein the CBS network with the particulates is applied by plating the metal substrate with the CBS network.

8. The conductive member of claim 1, wherein the CBS network has a controlled level and distribution of the particulates throughout the entire CBS network.

9. The conductive member of claim 1, wherein the CBS network comprises one of a yarn, a sheet, and a tape.

10. A cable comprising:
a jacket surrounding a core; and
a conductive member in the core, the conductive member comprising a metal substrate and a carbon-based substrate (CBS) network applied to the metal substrate, the CBS network having particulates embedded therein that provide cathodic protection for the metal substrate.

11. The cable of claim 10, wherein the particulates comprise iron particulates.

12. The cable of claim 10, wherein the particulates are metal particulates having a higher corrosion potential than the metal substrate.

13. The cable of claim 10, wherein the CBS network comprises one of a yarn, a sheet, and a tape.

14. The cable of claim 10, wherein the conductive member comprises a signal carrying conductor of the cable.

15. The cable of claim 10, further comprising a plurality of the conductive members twisted along a length of the cable to form a central conductor of the cable.

16. The cable of claim 10, wherein the conductive member surrounds the core and provides EMI shielding for the core.

17. The cable of claim 10, wherein the cable comprises a coaxial cable having an insulator and a second conductive member in the core, the insulator surrounding the conductive member, the second conductive member surrounding the insulator, the jacket surrounding the second conductive member, the second conductive member providing EMI shielding for the other conductive member, which is configured to convey electrical signals between a first end and a second end of the cable.

18. A method for manufacturing a conductive member comprising:
providing a metal substrate;
providing carbon-based substrate (CBS) based fibers to define a framework;
embedding particulates in the framework, the particulates having a higher corrosion potential than the metal substrate; and
applying the framework with the embedded particulates to the metal substrate to provide cathodic protection for the metal substrate.

19. The method of claim 18, wherein the embedding comprises immersing at least a portion of the framework in a metallic bath.

20. The method of claim 18, wherein the providing CBS based fibers comprises extracting CBS fibers from a CBS array to form the framework having a shape of one of a yarn, a tape or a sheet.
